(19) United States
(12) Patent Application Publication
(10) Pub. No.: US 2005/0052417 A1
(43) Pub. Date: Mar. 10, 2005

(54) Mouse control structure

(76) Inventor: Chung-Ping Chi, Chung Ho City (TW)

Correspondence Address: Yi-Wen Tseng, 509 ROOSEVELT BLVD. #D306, FALLS CHURCH, VA, 22044, US

(21) Appl. No.: 10/677,307

(22) Filed: Oct. 3, 2003

(30) Foreign Application Priority Data
Sep. 5, 2003 (TW) 092216069

(51) Int. Cl. G09G 5/08

(52) U.S. Cl. 345/163

(57) ABSTRACT

A mouse control structure, which forms a receiving space recessed from a top surface of a mouse. The receiving space is used to receive a control panel, which has a control key, a direction key, and an audio transceiving port. The control key, direction key and the audio transceiving port are used to control and integrate electronic devices such as DVD, TV, VIDEO, CD and recording pen. A covering plate is used to cover the receiving space, such that a complete mouse device is obtained.

### BACKGROUND OF THE INVENTION

The present invention relates to a mouse control structure and, more particularly, to an apparatus which integrates a mouse and a remote control together.

FIG. 1 shows a perspective view of a conventional notebook computer with a mouse and a remote control. The conventional notebook computer 10 and the wireless mouse 11 or the remote control 12 uses a detector 101 plugged in the notebook computer 10 to provide detection function; and thereby, the wireless mouse 11 or the remote control 12 can communicate with the notebook computer 10.

However, the conventional notebook computer with the wireless mouse or remote control has the following drawbacks.

1. As the wireless mouse 11 and the remote control 12 cannot be integrated together, the user has to buy two devices separately to increase the budget.

2. As various brands and types of wireless mouse and remote control have been developed. A single detector may not be operable for both the mouse and remote control made by different manufacturers. This causes great inconvenience in application.

3. The wireless mouse and the remote control are separate devices. Therefore, it is more easily to lose either one of them.

### BRIEF SUMMARY OF THE INVENTION

The present invention provides a mouse control structure, particularly a mouse integrated with a remote control, such that the drawbacks of the conventional design can be overcome.

The present invention further provides a mouse control structure with an integrated body to control DVD, TV, VIDEO, CD and recording pen. The application convenience is greatly enhanced.

The mouse control structure provided by the present invention comprises a mouse device with a receiving space recessed from a top surface thereof, and a control panel received in the receiving space. The control panel includes a control key, a direction key, and an audio transceiving port for controlling and integrating controls of DVD, TV, VIDEO, CD and recording pen in a single body. The mouse control structure further comprises a covering plate for covering the control panel.

### BRIEF DESCRIPTION OF THE DRAWINGS

These, as well as other features of the present invention, will become apparent upon reference to the drawings wherein:

FIG. 1 shows a perspective view of a notebook computer with a wireless mouse and a remote control;

FIG. 2 shows an exploded view of a mouse control structure provided by the present invention;

FIG. 3 shows a perspective view of the mouse control structure;

FIG. 4 shows a cross-sectional view of the mouse control structure;

FIG. 5 shows one operation status of the mouse control structure;

FIG. 6 shows the operation status of the mouse control structure from another view point;

FIG. 7 shows another operation status of the mouse control structure;

FIG. 8 shows another operation status of the mouse control structure;

FIG. 9 shows another operation status of the mouse control structure; and

FIG. 10 shows yet another operation status of the mouse control structure.

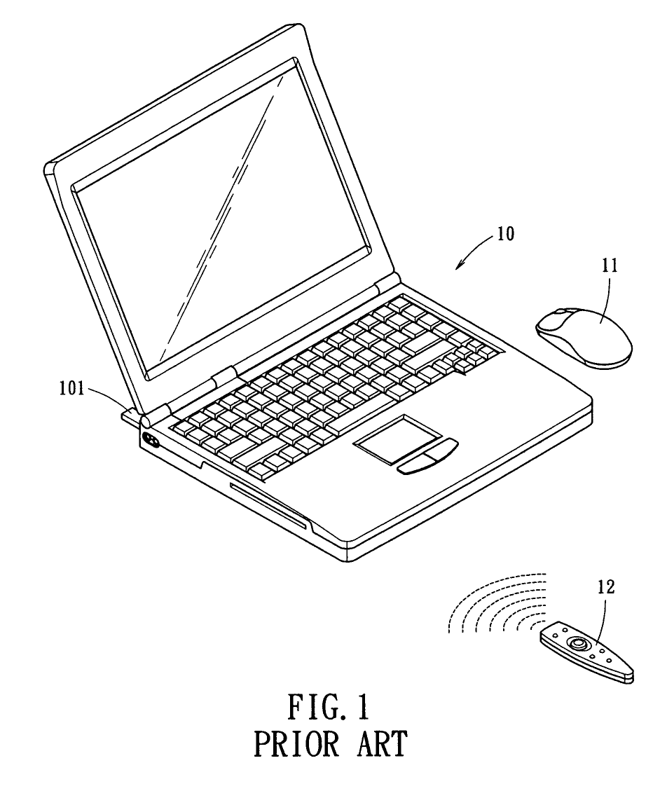

### DETAILED DESCRIPTION OF THE INVENTION

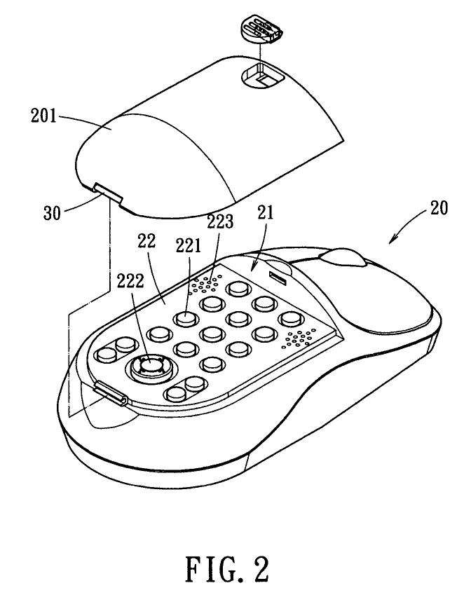

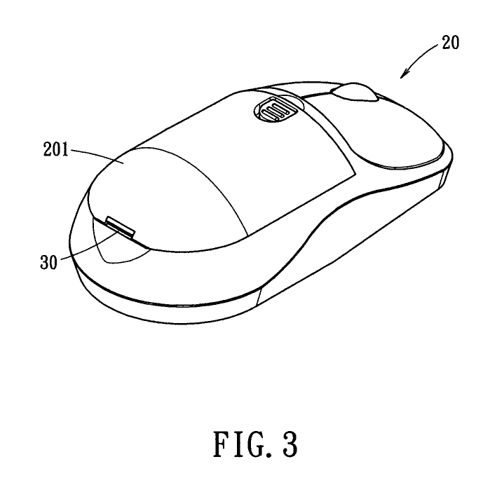

Referring to FIGS. 2 and 3, the present invention provides a mouse control structure, which integrates a mouse and a remote control together. As shown, the mouse control structure comprises a mouse 20 with a receiving space 21 recessed from a top surface of the mouse 20, and a transparent, translucent or color covering plate 201 for closing the receiving space 21.

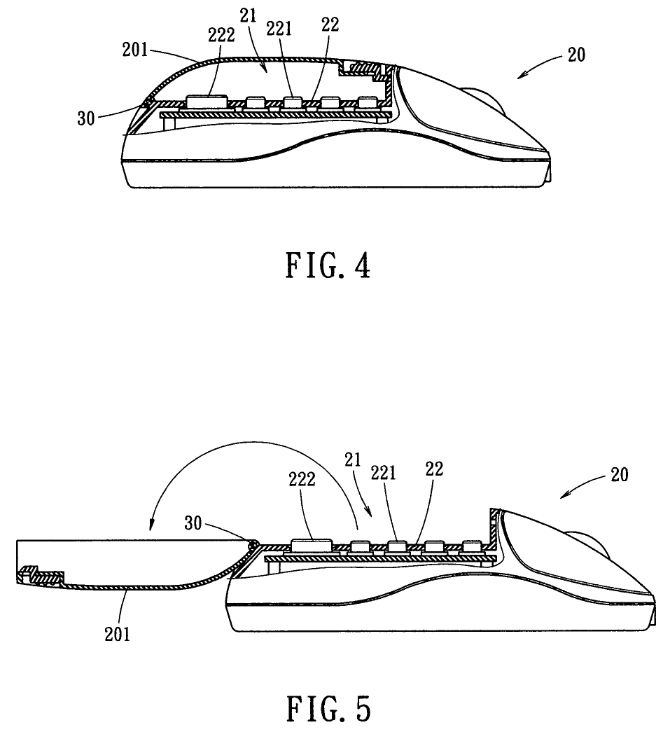

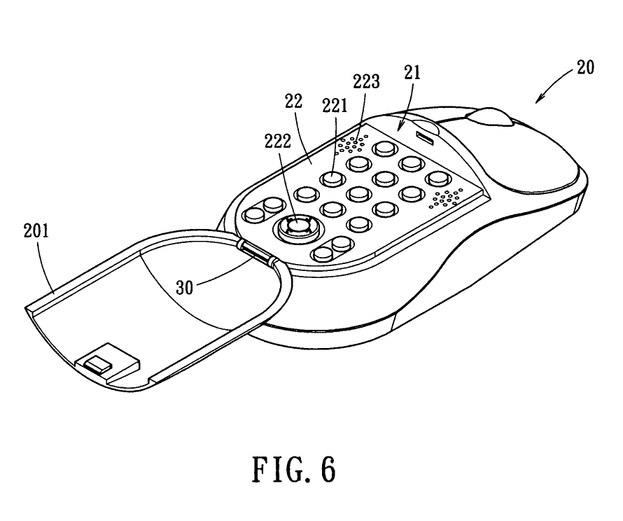

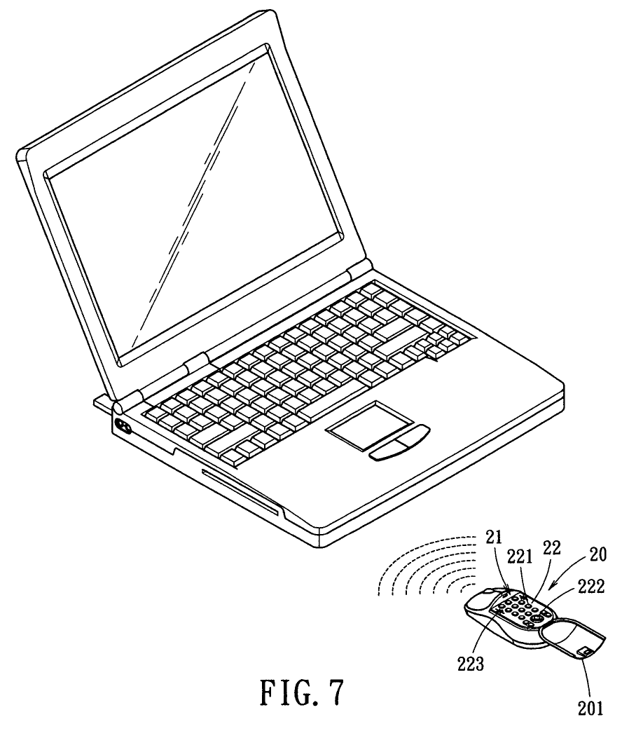

As shown in FIG. 2, the covering plate 201 can be removed or opened from the mouse 20 to expose the receiving space 21. Referring to FIGS. 2-7, by removing the covering plate, the control panel 22 is disposed in the receiving space 21. The control panel 22 includes a plurality of control keys 221, a direction key 222 and an audio transceiving port 223 for integrating controls of a DVD, a TV, a VIDEO, a CD and a recording pen.

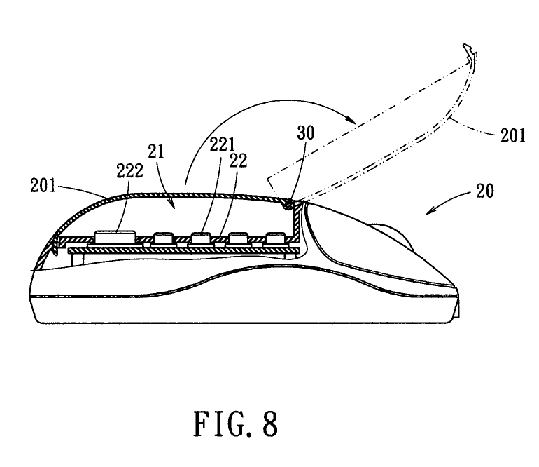

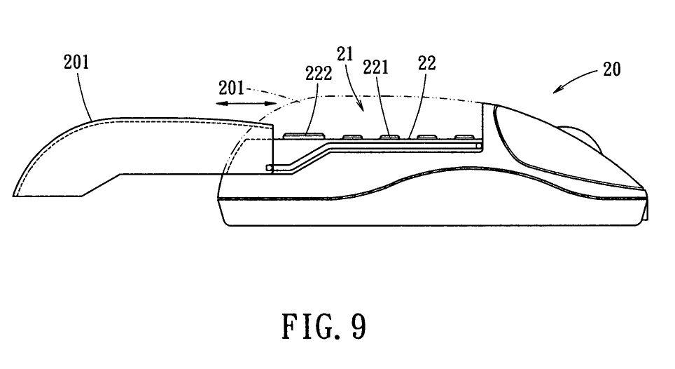

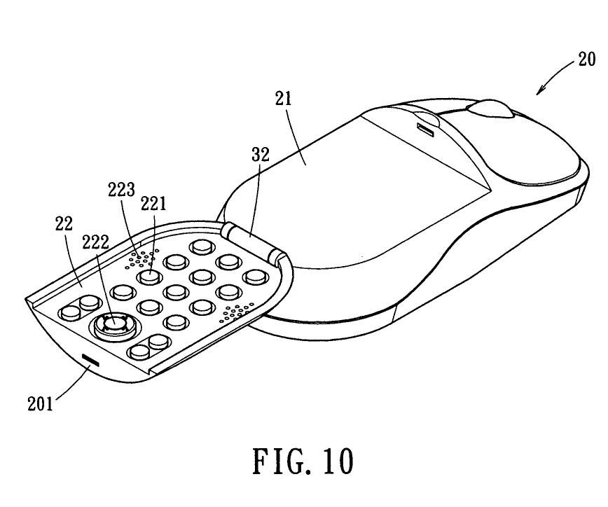

Referring to FIGS. 8-10, operation status for various embodiments is illustrated. In these embodiments, the covering plate 201 is pivotally connected to the device 20 by pivotal axis 30, pivot slot 31 or pivot ring 32. The control panel 22, instead of being formed as a separate device to be disposed in the receiving space 21, can be formed integrally on an internal surface of the covering plate 201. By flipping open the covering plate 201, the control panel 22 is facing upwards allows the user to operate.

The mouse control structure provides by the present invention provides at least the following advantages.

1. The single structure is operative to control various electronic devices.

2. The integrated structure meets with the requirement of the modem multimedia application.

3. The integrated structure provides more convenience to the user.

4. The integrated structure is more economic and eliminate the problem of incompatibility.

This disclosure provides exemplary embodiments of the present invention. The scope of this disclosure is not limited by these exemplary embodiments. Numerous variations, whether explicitly provided for by the specification or implied by the specificafion, such as variations in shape, structure, dimension, type of material or manufacturing process may be implemented by one of skill in the art in view of this disclosure.

1. A mouse control structure, comprising a receiving space recessed from a top surface of a mouse, and a covering plate to cover the receiving space.

2. The mouse control structure according to claim 1, further comprising a control panel disposed within the receiving space.

3. The mouse control structure according to claim 1, wherein the control panel includes a control key, a direction key and an audio transceiving structure for integrating controls of a DVD, a TV, a VIDEO, a CD and a recording pen therein.

4. The mouse control structure according to claim 1, wherein the covering plate is removable from the mouse.

5. The mouse control structure according to claim 1, wherein the covering plate is pivotally connected to the mouse by a pivot axis, a pivot slot or a pivot ring.

6. The mouse control structure according to claim 1, wherein the covering plate is flipped to expose the receiving space.

7. The mouse control structure according to claim 6, further comprising a control panel attached to an interior surface of the covering plate.

8. The mouse control structure according to claim 1, wherein the covering plate is transparent, translucent or colored.

9. A mouse control structure, comprising a mouse with a receiving space recessed from a top surface thereof, a control panel disposed in the receiving space, and a covering plate removably or opernably connected to the mouse for covering the control panel in the receiving space.

10. The mouse control structure according to claim 9, wherein the control panels comprises a plurality of control keys, a direction key and an audio transceiving structure.

11. The mouse control structure according to claim 9, wherein the control panel integrates controls of DVD, TV, VIDEO, CD and recording pen therein.

12. The mouse control structure according to claim 9, wherein one side of the covering plate is pivotally connected to the mouse.

13. The mouse control structure according to claim 9, wherein the covering plate is connected to the mouse by a pivot axis, a pivot slot or a pivot ring.

14. The mouse control structure according to claim 9, wherein the covering plate is transparent or colored.
